(19) United States
(12) Patent Application Publication
(10) Pub. No.: US 2009/0200287 A1
(43) Pub. Date: Aug. 13, 2009

(54) HEATING UNIT FOR OVEN

(76) Inventor: Yeon chang Kim, Gyeonggi-do (KR)

Correspondence Address: HOLLAND & HART, LLP, P.O BOX 8749, DENVER, CO, 80201, US

(21) Appl. No.: 12/093,476

(22) PCT Filed: Aug. 14, 2006
(86) PCT No.: PCT/KR06/03174

§ 371 Date: Sep. 15, 2008

(30) Foreign Application Priority Data
Nov. 18, 2005 (KR) 10-2005-0110817
Aug. 11, 2006 (KR) 10-2006-0015437
Aug. 14, 2006 (KR) 10-2006-0076268

(51) Int. Cl. A21B 1/22

(52) U.S. Cl. 219/399

(57) ABSTRACT

Provided is a heating unit for an oven that does not employ conventional heat rays, lamps, and high frequency to cook food, but instead uses a ceramic heater and a heating element coated with ceramic to cook food, so that far-infrared radiation and anions are emitted during cooking to increase the taste of cooked food and allow food to be properly cooked without being burnt, thereby increasing the overall effectiveness of the oven. The heating unit includes a heating element, a controller, and a heat blocking plate. The heating element includes a ceramic heater that emits heat using supplied electrical power, and a heat radiating plate that radiates the heat emitted by the ceramic heater toward food. The heat blocking plate blocks the heat emitted by the ceramic heater from being conducted outside the oven. The controller blocks the electrical power supplied to the ceramic heater and sounds an alarm or illuminates a warning light, according to a control command issued by a microprocessor, when a temperature of the heat radiated by the heat radiating plate exceeds a preset temperature.

### TECHNICAL FIELD

The present invention relates to a heating unit for an oven that does not employ conventional heat rays, lamps, and high frequency to cook food, but instead uses a ceramic heater and a heating element coated with ceramic to cook food, so that far-infrared radiation and anions are emitted during cooking to increase the taste of cooked food and allow food to be properly cooked without being burnt, thereby increasing the overall effectiveness of the oven.

### BACKGROUND ART

As is widely known, the heating methods of ovens and other cooking devices use heat rays, high frequency, etc. to heat food. Conventional heating elements such as heat radiators apply heat directly to food so that the surface of the food is often overcooked and burnt. When meats and fish are burnt, the carcinogen benzopyrene is generated, and heating of nitride produces nitrosamine, which can cause stomach or esophageal cancer.

While on the one hand, high frequencies (radiation) used in microwave ovens are able to evenly cook the outside and inside of food through the collision of high frequency waves, microwave ovens consume much power, use expensive high frequency generators that make maintenance and repairs costly, and generate radiation that may be, according to some, harmful to the human body under normal conditions of microwave use. Furthermore, when radiation leaks outside a microwave oven, it has the potential to cause damage to human tissue. Therefore, products that use radiation as a heating source must have an accompanying device that blocks the radiation, which further increases product cost.

### DISCLOSURE OF INVENTION

### Technical Problem

To solve the above problem, the present invention provides a heating unit for an oven employing a heating element formed of a ceramic heater and (a ceramic-coated heating plate), where the coupling structure of the ceramic heater and the heating plate is simple, so that assembly thereof is made easy.

Another object of the present invention is to provide a heating unit for an oven with a safety feature that detects the heated temperature of the oven and sounds an alarm or displays a warning light when the temperature exceeds a preset temperature.

### Technical Solution

According to an aspect of the present invention, there is provided a heating unit of an oven, including: a heating element including a ceramic heater for emitting heat using supplied electrical power, and a heat radiating plate for radiating the heat emitted by the ceramic heater toward food; and a controller for blocking the electrical power supplied to the ceramic heater and sounding an alarm or illuminating a warning light, according to a control command issued by a microprocessor, when a temperature of the heat radiated by the heat radiating plate exceeds a preset temperature.

The heating element may further include a heat blocking plate for blocking the heat emitted by the ceramic heater from being conducted outside the oven.

The heat radiating plate may be formed of a heat conductive metal plate coated with a ceramic and paint mixture at a high temperature.

The heat radiating plate may be in a rectangular plate shape with ‘L’ shaped corner hooks, a band spring may be fixed respectively between pairs of the ‘L’ shaped corner hooks, the ceramic heater may be disposed between the band springs and the heat radiating plate, and the heat radiating plate and the ceramic heater may be coupled through a pressing force of the plate spring pressing the ceramic heater against the heat radiating plate.

The heat radiating plate may form a pair of mutually facing ‘L’ shaped hooks running along a same or similar length of the heat radiating plate at either side thereof, a band-shaped plate spring may be fixed between the pair of hooks, the ceramic heater may be positioned between the plate spring and the heat radiating plate, and the heat radiating plate and the ceramic heater may be coupled through a pressing force of the plate spring.

The heat radiating plate may be provided as a pair of parallel planar plates, the ceramic heater may be interposed between the pair of plates, and the pair of plates may be screwed together.

The heat radiating plate may include an installation recess formed in an upper surface thereof, the ceramic heater may be inserted in the installation recess, a plate spring may be installed at an opening of the installation recess, and the heat radiating plate and the ceramic plate may be coupled through a pressing force of the plate spring.

The heat radiating plate may be two-dimensional or three-dimensionally shaped, and include a plurality of heat radiating fins that are intaglio or protruding portions integrally or separately formed on a surface thereof.

The heating element may further include a deflector installed therebehind for deflecting heat.

The deflector may have indentations or protrusions formed on a front surface thereof.

The heating element may further include a cover plate for covering a rear surface of the heat radiating plate.

### ADVANTAGEOUS EFFECTS

An advantage of the heating unit for an oven according to the present invention is that it does not employ conventional heat rays and high frequency to cook food, but instead uses a ceramic heater and a heating element coated with ceramic to cook food, so that far-infrared radiation and anions are emitted during cooking to increase the taste of cooked food and allow food to be properly cooked without being burnt, thereby making cooking easier.

Another advantage of the heating unit for an oven according to the present invention is that it includes a safety device to obviate the possibility of food being burnt or fires arising due to overheating by a heating element.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a phantom perspective view showing heating elements installed in an oven according to the present invention;

FIG. 2 is perspective view showing the structure of a heating element according to the first embodiment of the present invention;

FIG. 3 is a sectional view of the components in FIG. 2 in a coupled state;

FIG. 4 is a perspective view showing the structure of a heating element according to the second embodiment of the present invention;

FIG. 5 is a sectional view of the components in FIG. 4 in a coupled state;

FIG. 6 is a perspective view showing the structure of a heating element according to the third embodiment of the present invention;

FIG. 7 is a sectional view of the components in FIG. 6 in a coupled state;

FIG. 8 is a perspective view showing the structure of a heating element according to the fourth embodiment of the present invention;

FIG. 9 is a sectional view of the components in FIG. 8 in a coupled state;

FIGS. 10 through 14 show different embodiments of a heating plate according to the present invention;

FIG. 15 is a block diagram of a controller according to the present invention;

FIG. 16 is a perspective view showing the structure of a heating element according to the fifth embodiment of the present invention;

FIG. 17 is a perspective view showing the structure of a heating element according to the sixth embodiment of the present invention;

FIG. 18 is a perspective view showing the structure of a heating element according to the seventh embodiment of the present invention;

FIG. 19 is a perspective view showing the coupling of a heating element and a reflector according to the present invention; and

FIG. 20 shows various types of ceramic heaters.

### BEST MODE FOR CARRYING OUT THE INVENTION

Hereinafter, preferred embodiments of a heating unit for an oven according to the present invention will be described in detail with reference to the accompanying drawings.

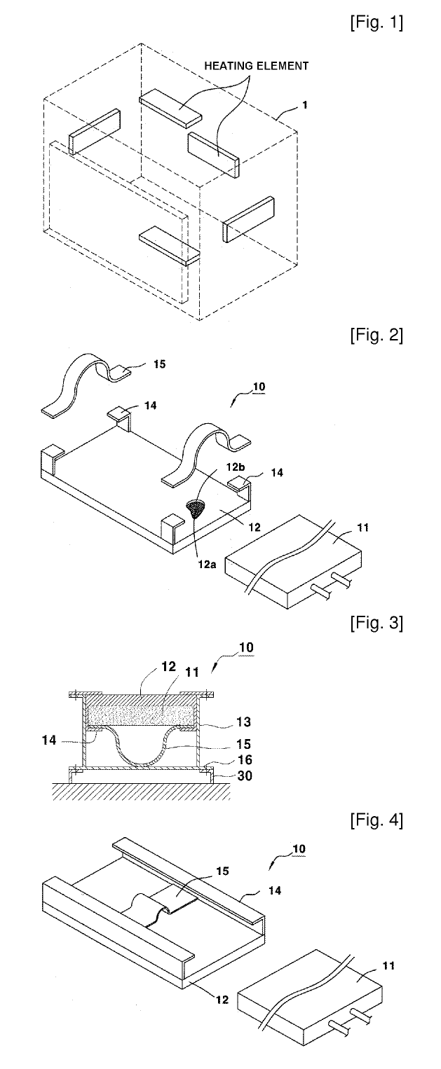

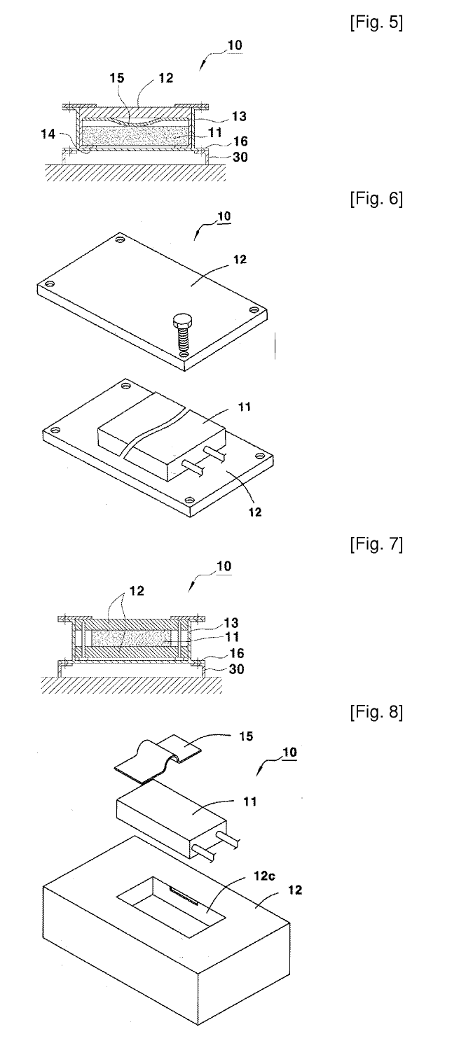

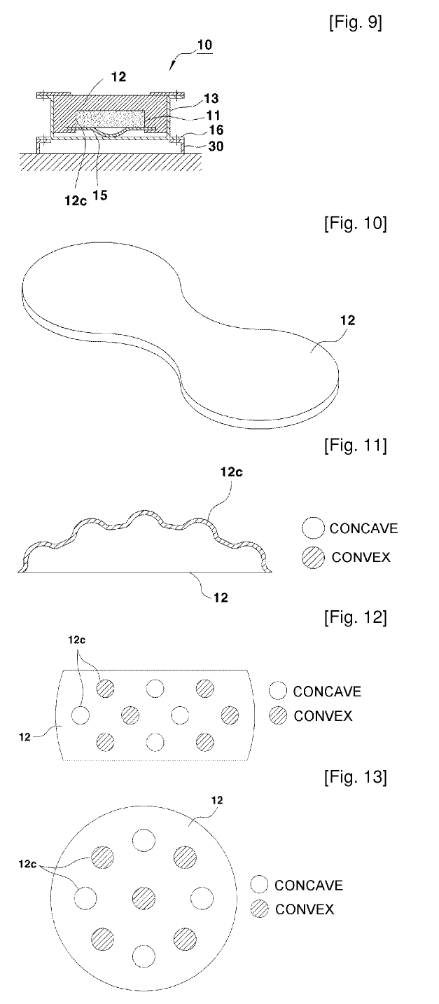

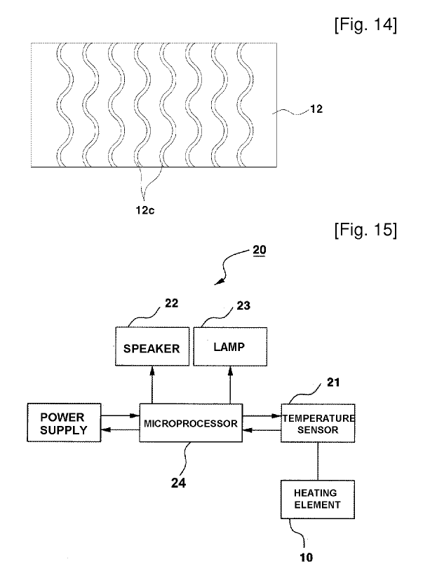

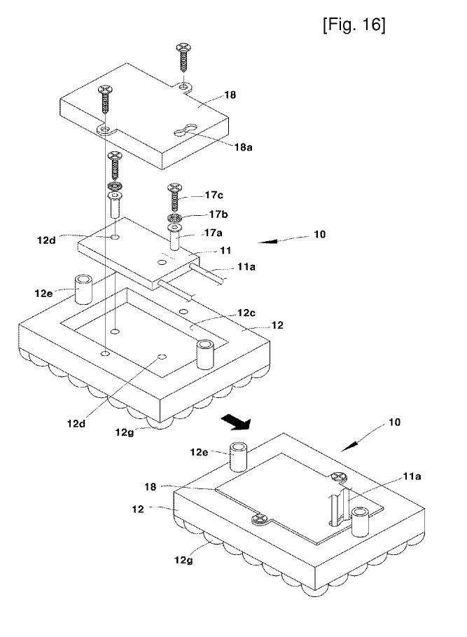

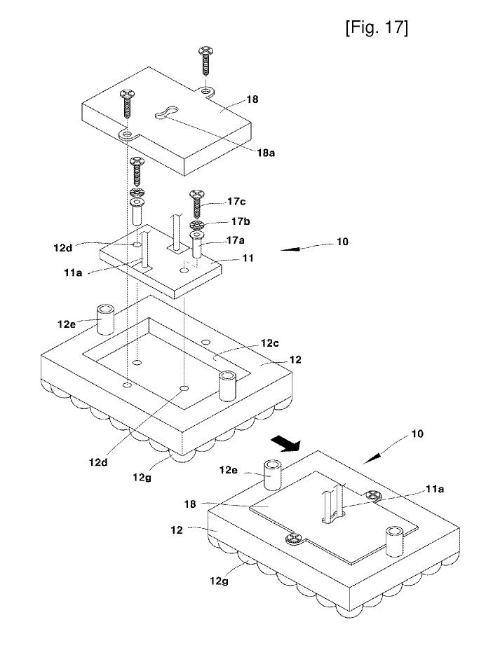

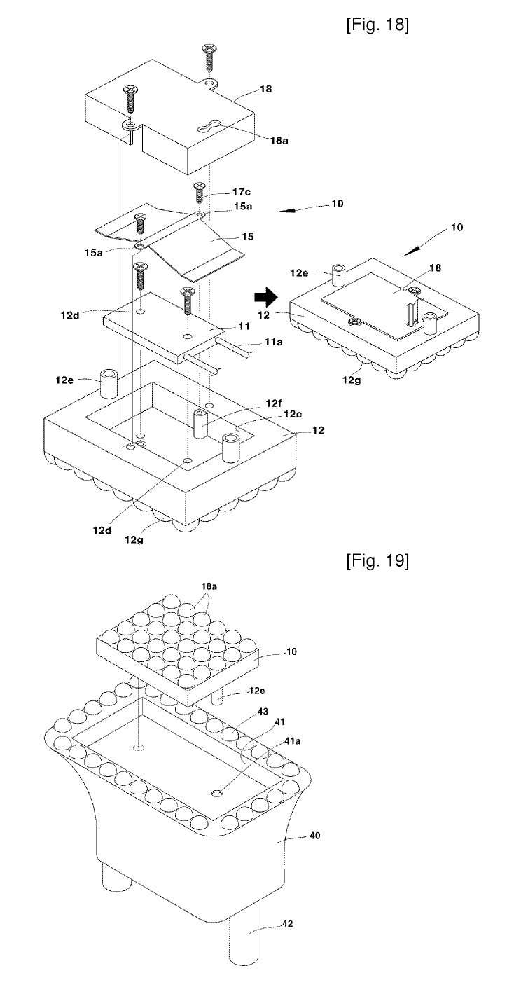

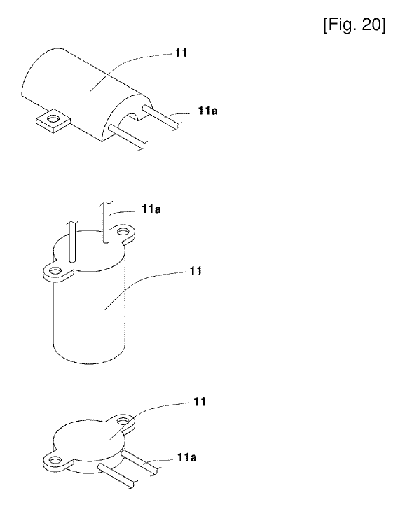

FIG. 1 is a phantom perspective view showing heating elements installed in an oven according to the present invention, FIG. 2 is perspective view showing the structure of a heating element according to the first embodiment of the present invention, FIG. 3 is a sectional view of the components in FIG. 2 in a coupled state, FIG. 4 is a perspective view showing the structure of a heating element according to the second embodiment of the present invention, FIG. 5 is a sectional view of the components in FIG. 4 in a coupled state, FIG. 6 is a perspective view showing the structure of a heating element according to the third embodiment of the present invention, FIG. 7 is a sectional view of the components in FIG. 6 in a coupled state, FIG. 8 is a perspective view showing the structure of a heating element according to the fourth embodiment of the present invention, FIG. 9 is a sectional view of the components in FIG. 8 in a coupled state, FIGS. 10 through 14 show different embodiments of a heating plate according to the present invention, FIG. 15 is a block diagram of a controller according to the present invention, FIG. 16 is a perspective view showing the structure of a heating element according to the fifth embodiment of the present invention, FIG. 17 is a perspective view showing the structure of a heating element according to the sixth embodiment of the present invention, FIG. 18 is a perspective view showing the structure of a heating element according to the seventh embodiment of the present invention, FIG. 19 is a perspective view showing the coupling of a heating element and a reflector according to the present invention, and FIG. 20 shows various types of ceramic heaters.

As shown in the diagrams, the present invention provides a heating unit for an oven that includes a heating element 10, and a controller 20 capable of forecasting an overheating of the heating element and automatically shutting off power to an overheated heating element.

First, the heating element 10 is formed of a ceramic heater 11 that emits heat when supplied with electrical power, a heat radiating plate 12 that radiates the heat emitted from the ceramic heater towards food to be cooked, and a heat blocking plate 13 that blocks the heat emitted from the ceramic heater from being conducted out of the oven.

Here, the heat radiating plate 12 may be formed selectively of any metal plate 12a including aluminum, nickel silver, iron, gold, silver, etc. that has high heat conductivity, and a coating material 12b that is a compound of ceramic powder mixed with a paint is coated on the metal plate at high temperature. The coating temperature is approximately 180°-400° C., which is a suitable temperature for mixing ceramic powder and paint. Also, the shape of the heat radiating plate 12 may be a two-dimensional rectangular (FIGS. 2 through 8), circular, triangular, or other multi-angular or close-lined shape (FIG. 10). While the shape does not affect the function of the plate, it may be changed according to its installation location and installability.

Preferably, the shape of the heat radiating plate 12 may have a three-dimensional domed shape, as shown in FIGS. 10 through 14, and include intaglio and/or protruding integrally formed radiating fins 12c on its surface, in order to increase the surface area for radiating heat in an inward or outward direction.

Also, many other shapes (such as wave-shaped radiating fins 12c) may be separately or integrally formed on the heat radiating plate to increase heat radiating effectiveness.

Additionally, the thickness of the heat radiating plate 12 may be 0.05-50 mm in consideration of conducting time and conducting heat, its length may be 10-500 mm in consideration of its installed location in an oven, and its width may be 0.5-500 mm in consideration of its installed location and installed number. The above conditions apply to a rectangular heat radiating plate, and dimensions for alternately shaped plates may be accordingly allotted.

The capacity of the ceramic heater 11 corresponds to that of the oven and is set at 15-500Ω, and its thickness, length, and width may respectively be 0.01-50 mm, 0.5-500 mm, and 0.2-500 mm. Also, it may be formed in the same shape, i.e., rectangular, circular, triangular, or other multi-angular shape as the conductive plate.

The ceramic heater 11 may be formed in the shape of a circular plate, a cylindrical column, or a semi-cylinder (as shown in FIG. 20), but is not restricted thereto and may be take one of many shapes.

Also, the coupling structure of the heat radiating plate 12 and the ceramic heater 11 may take various forms.

Referring to FIGS. 2 and 3, in the first embodiment of the present invention, the heat radiating plate 12 is formed in a rectangular shape with ‘L’ shaped hooks 14 formed at the corners and a band-type plate spring 15 inserted and fixed between two hooks 14 at either end. The ceramic heater 11 is disposed between the plate springs and the heat radiating plate, such that the heat radiating plate and the ceramic heater are coupled by means of the elasticity (pressing force of the plate springs 15).

Referring to FIGS. 4 and 5, in the second embodiment of the present invention, the heat radiating plate 12 is formed with a pair of ‘L’ shaped hooks 14 having the same or a similar length of the heat radiating plate disposed on either side thereof facing one another. A plate spring 15 is hooked on the two hooks, and the ceramic heater 11 is positioned between the plate spring and the heat radiating plate, so that the pressing force of the plate spring couples the heat radiating plate and the ceramic heater.

Referring to FIGS. 6 and 7, in the third embodiment of the present invention, the heat radiating plate 12 is provided as a pair of parallel planes between which the ceramic heater 11 is disposed, where the two heat radiating plates 12 are fastened together with screws. In this structure, because there are two heat radiating plates 12, heat is radiated from both sides of the unit. Therefore, the installation location may be within the open inner space of the oven. In all the other embodiments, the heating unit is installed on the walls of the oven.

Referring to FIGS. 8 and 9, in the fourth embodiment of the present invention, the heat radiating plate 12 includes an installation recess 12c in which the ceramic heater 11 is inserted, after which a plate spring 15 is installed at the open side to provide pressing force to retain the coupling of the heat radiating plate and the ceramic heater.

The controller 20, as shown in FIG. 15, includes a temperature sensor 21 for sending the temperature of the heat radiate by the heating element, and a microprocessor 23 that issues a command to emit an aural alarm through a speaker 22 or a visual warning through a lamp 23 when the temperature sensed by the temperature sensor exceeds a preset temperature, and simultaneously (or after a predetermined time elapses) issues a command to block the supply of power to the heating element 10.

The thus structured heating element 10 may be provided separately or in groups on the respective walls of an oven. When more than one element is installed on one wall, a predetermined gap may be provided between adjacent heating elements to maximize the heat radiating area.

Also, when this heating element 10 is fixed to the wall of an oven, coupling members 16 of the heating element that has been preassembled may be fixed with screws to pre-installed brackets 30 on the wall of the oven. Alternate installing methods may be used.

Referring to FIG. 16, in the fifth embodiment of the present invention, the installation recess 12c is formed in the rear surface of the heat radiating plate 12, and the ceramic heater 11 is inserted into the installation recess 12c, whereupon a rivet 17a, a spring washer 17b, and a screw 17c are used to couple both components together. Here, the spring washer 17b has a predetermined tensility to prevent damage to the breakable ceramic heater 11 when the components are fastened together. Also, a cover plate 18 is fastened by the screws at the rear surface of the heat radiating plate 12 to seal the installation recess 12c. Here, a coupling boss 12e may be formed on the rear surface of the heat radiating plate 12 to couple the heat radiating plate to the wall of the oven, and a through-hole 18a may be formed in a predetermined portion of the cover plate 18 to pass the terminals 11a of the ceramic heater 11 through.

Referring to FIG. 17, in the sixth embodiment of the present invention, the terminals 11a of the ceramic heater 11 are formed in the center thereof, and the through-holes 18a of the cover plate 18 may be formed to enclose the terminals 11a. Aside from this discrepancy, this embodiment is the same as the fifth embodiment.

The heating element 10 according to the seventh embodiment of the present invention, as shown in FIG. 18, may include a plate spring 15 interposed between the ceramic heater 11 and the cover plate 18, where the plate spring 15 includes fastening holes 15a formed at the center on either side thereof to correspond to fastening holes 12f formed inside the installation recess 12c of the heat radiating plate 12, so that the two components may be coupled using screws through the respective fastening holes. Beside this difference, this embodiment is the same as the fifth embodiment.

Referring to FIG. 19, the heating element 10 according to the present invention further includes a deflector 40 for deflecting heat. Here, the coupling structure of the heating element 10 and the deflector 40 has an inserting recess 41 formed in the center of the deflector 40 to insert the heating element 10 in, and boss coupling holes 41a formed within the insert recess to insert coupling bosses 12e of the heat radiating plate 12 of the heating element 10. At the rear of the deflector 40 are fixing mounts 42 for installing the deflector on the wall of the oven.

Here, the front surfaces of the heat radiating plate 12 of the heating element 10 and the deflector 40 have concave or convex portions 12g or 43 formed thereon, in order to increase the surface area (and therefore, the effectiveness) of heat radiation and deflection.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The heating unit for an oven of the present invention described above uses ceramic (that is capable of emitting far-infrared radiation) as heating elements, to increase cooking effectiveness and provide a safe environment for the human body. Also, as commonly known, far-infrared radiation is especially effective in evenly cooking the outside and inside of food, so that the taste of food is improved and burning of food can be prevented for better health, giving the heating unit of the present invention a high industrial applicability.

1. A heating unit of an oven, comprising:
a heating element including a ceramic heater for emitting heat using supplied electrical power, and a heat radiating plate for radiating the heat emitted by the ceramic heater toward food; and
a controller for blocking the electrical power supplied to the ceramic heater and sounding an alarm or illuminating a warning light, according to a control command issued by a microprocessor, when a temperature of the heat radiated by the heat radiating plate exceeds a preset temperature.

2. The heating unit of claim 1, wherein the heating element further includes a heat blocking plate for blocking the heat emitted by the ceramic heater from being conducted outside the oven.

3. The heating unit of claim 1, wherein the heat radiating plate is formed of a heat conductive metal plate coated with a ceramic and paint mixture at a high temperature.

4. The heating unit of claim 1, wherein the heat radiating plate is in a rectangular plate shape with ‘L’ shaped corner hooks, a band spring is fixed respectively between pairs of the ‘L’ shaped corner hooks, the ceramic heater is disposed between the band springs and the heat radiating plate, and the heat radiating plate and the ceramic heater are coupled through a pressing force of the plate spring pressing the ceramic heater against the heat radiating plate.

5. The heating unit of claim 1, wherein the heat radiating plate forms a pair of mutually facing ‘L’ shaped hooks running along a same or similar length of the heat radiating plate at either side thereof, a band-shaped plate spring is fixed between the pair of hooks, the ceramic heater is positioned between the plate spring and the heat radiating plate, and the heat radiating plate and the ceramic heater are coupled through a pressing force of the plate spring.

6. The heating unit of claim 1, wherein the heat radiating plate is provided as a pair of parallel planar plates, the ceramic heater is interposed between the pair of plates, and the pair of plates are screwed together.

7. The heating unit of claim 1, wherein the heat radiating plate includes an installation recess formed in an upper surface thereof, the ceramic heater is inserted in the installation recess, a plate spring is installed at an opening of the installation recess, and the heat radiating plate and the ceramic plate are coupled through a pressing force of the plate spring.

8. The heating unit of claim 1, wherein the heat radiating plate is two-dimensional or three-dimensionally shaped, and includes a plurality of heat radiating fins that are intaglio or protruding portions integrally or separately formed on a surface thereof.

9. The heating unit of claim 1, wherein the heating element further includes a deflector installed therebehind for deflecting heat.

10. The heating unit of claim 9, wherein the deflector has indentations or protrusions formed on a front surface thereof.

11. The heating unit of claim 1, wherein the heating element further includes a cover plate for covering a rear surface of the heat radiating plate.
